(19) United States
(12) Patent Application Publication
(10) Pub. No.: US 2026/0189112 A1
(43) Pub. Date: Jul. 2, 2026

(54) LAMINATED IRON CORE MANUFACTURING APPARATUS

(71) Applicant: Kabushiki Kaisha F.C.C., Hamamatsu-shi (JP)

(72) Inventors: Michiharu YONEZAWA, Hamamatsu-shi (JP); Takashi AMANO, Hamamatsu-shi (JP)

(21) Appl. No.: 19/544,083

(22) Filed: Feb. 19, 2026

Related U.S. Application Data
(63) Continuation of application No. PCT/JP2024/026795, filed on Jul. 26, 2024.

(30) Foreign Application Priority Data
Sep. 19, 2023 (JP) 2023-151142
Apr. 17, 2024 (JP) 2024-066957

(51) Int. Cl. H02K 15/0273

(52) U.S. Cl. CPC H02K 15/0273

(57) ABSTRACT

A laminated iron core manufacturing apparatus includes a lower mold including a die assembly provided with a die hole assembly, an upper mold including punches conforming to the die hole assembly, an adhesive applicator to apply an adhesive to a lower surface of a metal plate, and a controller configured or programmed to control the upper mold and the adhesive applicator. The controller is configured or programmed to include a movement controller configured or programmed to control movement of the upper mold in an up-down direction, and an application controller configured or programmed to change a start timing that is a timing when the adhesive applicator starts applying the adhesive to the lower surface of the metal plate.

### CROSS REFERENCE TO RELATED APPLICATIONS

This application claims the benefit of priority to Japanese Patent Application No. 2023-151142 filed on Sep. 19, 2023, and Japanese Patent Application No. 2024-066957 filed on Apr. 17, 2024, and is a Continuation Application of PCT Application No. PCT/JP 2024/026795 filed on Jul. 26, 2024. The entire contents of each application are hereby incorporated herein by reference.

### BACKGROUND OF THE INVENTION

### 1. Field of the Invention

The present invention relates to laminated iron core manufacturing apparatuses.

### 2. Description of the Related Art

A laminated iron core for use in, for example, a motor, is formed by providing iron cores (or core components) by punching a band-shaped metal plate (e.g., a band-shaped steel plate) into predetermined shapes, and laminating and integrating the iron cores provided. Such a laminated iron core is formed by laminating and integrating iron cores through, for example, swaging, welding, or bonding. JP 2001-321850 A, for example, discloses a manufacturing apparatus to laminate iron cores using an adhesive so as to manufacture a laminated iron core including the iron cores bonded together. According to JP 2001-321850 A, a lower mold including a die is provided with an adhesive applicator, and when a thin steel plate has reached a press timing bottom dead point, an adhesive discharged from a discharge nozzle of the adhesive applicator is applied to a predetermined position on a lower surface of the thin steel plate.

### SUMMARY OF THE INVENTION

When an adhesive is applied to a lower surface of a metal plate, the adhesive needs to be accurately applied to a predetermined position on the lower surface of the metal plate. Inaccurate application of the adhesive may prevent proper bonding between iron cores. This may unfortunately reduce the strength of a resulting laminated iron core.

Example embodiments of the present invention provide laminated iron core manufacturing apparatuses, each of which is able to accurately apply an adhesive to a predetermined position on a lower surface of a metal plate.

A laminated iron core manufacturing apparatus according to an example embodiment of the present invention is an apparatus to manufacture a laminated iron core including iron cores laminated and bonded together. The manufacturing apparatus includes a lower mold including a die provided with a die hole, an upper mold including a punch conforming to the die hole, an adhesive applicator provided in the lower mold to apply an adhesive to a lower surface of a band-shaped metal plate, and a controller configured or programmed to control the upper mold and the adhesive applicator. The controller is configured or programmed to include a movement controller configured or programmed to control movement of the upper mold in an up-down direction, and an application controller configured or programmed to change a start timing that is a timing when the adhesive applicator starts applying the adhesive to the lower surface of the metal plate.

A laminated iron core manufacturing apparatus according to an example embodiment of the present invention includes the controller configured or programmed to control the upper mold and the adhesive applicator. The application controller of the controller is configured or programmed to change the start timing, which is the timing when the adhesive applicator starts applying the adhesive to the lower surface of the metal plate. The above-described example embodiment is able to suitably change the timing to start the adhesive application. Accordingly, the above-described example embodiment is able to more accurately apply the adhesive to a predetermined position on the lower surface of the metal plate at a predetermined timing.

Another laminated iron core manufacturing apparatus according to an example embodiment of the present invention is an apparatus to manufacture a laminated iron core including iron cores laminated and bonded together. The manufacturing apparatus includes a lower mold including a die provided with a die hole, an upper mold including a punch conforming to the die hole, an adhesive applicator provided in the lower mold to apply an adhesive to a lower surface of a band-shaped metal plate, and a controller configured or programmed to control the upper mold and the adhesive applicator. The controller is configured or programmed to include a movement controller configured or programmed to control movement of the upper mold in an up-down direction, and an application controller configured or programmed to change a finish timing that is a timing when the adhesive applicator finishes applying the adhesive to the lower surface of the metal plate.

The another laminated iron core manufacturing apparatus according to an example embodiment of the present invention includes the controller configured or programmed to control the upper mold and the adhesive applicator. The application controller of the controller is configured or programmed to change the finish timing, which is the timing when the adhesive applicator finishes applying the adhesive to the lower surface of the metal plate. The above-described example embodiment is able to suitably change the timing for finishing the adhesive application. Accordingly, the above-described example embodiment is able to more accurately apply the adhesive to a predetermined position on the lower surface of the metal plate at a predetermined timing.

Still another laminated iron core manufacturing apparatus according to an example embodiment of the present invention is an apparatus to manufacture a laminated iron core including iron cores laminated and bonded together. The manufacturing apparatus includes a lower mold including a die provided with a die hole, an upper mold including a punch conforming to the die hole, an adhesive applicator provided in the lower mold to apply an adhesive to a lower surface of a band-shaped metal plate, and a controller configured or programmed to control the upper mold and the adhesive applicator. The controller is configured or programmed to include a movement controller configured or programmed to control movement of the upper mold in an up-down direction, and an application controller configured or programmed to change a time interval between a start and a finish of application of the adhesive from the adhesive applicator to the lower surface of the metal plate.

The still another laminated iron core manufacturing apparatus according to an example embodiment of the present invention includes the controller configured or programmed to control the upper mold and the adhesive applicator. The application controller of the controller is configured or programmed to change the time interval between the start and finish of application of the adhesive from the adhesive applicator to the lower surface of the metal plate. The above-described example embodiment is able to suitably change the period during which the adhesive is to be applied. Accordingly, the above-described example embodiment is able to more accurately apply the adhesive to a predetermined position on the lower surface of the metal plate at a predetermined timing.

Example embodiments of the present invention provide laminated iron core manufacturing apparatuses, each of which is capable of accurately applying an adhesive to a predetermined position on a lower surface of a metal plate.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of a laminated iron core manufacturing apparatus according to an example embodiment of the present invention.

FIG. 2 is a perspective view of a laminated iron core according to an example embodiment of the present invention.

FIG. 3 is a plan view of a lower mold according to an example embodiment of the present invention.

FIG. 4A is a cross-sectional view of a lifter and its adjacent structure in an example embodiment of the present invention.

FIG. 4B is a cross-sectional view illustrating a stripper plate pressing a metal plate downward in an example embodiment of the present invention.

FIG. 4C is a cross-sectional view illustrating the metal plate sandwiched between the stripper plate and a die plate in an example embodiment of the present invention.

FIG. 5 is a cross-sectional view of the laminated iron core manufacturing apparatus according to an example embodiment of the present invention.

FIG. 6A is a schematic diagram illustrating a positional relationship between a pilot pin and a pilot hole in an example embodiment of the present invention.

FIG. 6B is a schematic diagram illustrating the pilot pin inserted through the pilot hole in an example embodiment of the present invention.

FIG. 6C is a schematic diagram illustrating one-half of an insertion portion of the pilot pin inserted through the pilot hole in an example embodiment of the present invention.

FIG. 7A is a cross-sectional view illustrating a normal state of an adhesive applicator in an example embodiment of the present invention.

FIG. 7B is a cross-sectional view illustrating an adhesive being fed to an adhesive container of the adhesive applicator in an example embodiment of the present invention.

FIG. 7C is a cross-sectional view illustrating the adhesive discharged from a nozzle of the adhesive applicator in an example embodiment of the present invention.

FIG. 7D is a cross-sectional view illustrating the adhesive (which has been discharged from the nozzle of the adhesive applicator) adhering to a lower surface of a band-shaped metal plate in an example embodiment of the present invention.

FIG. 8 is a cross-sectional view illustrating the stripper plate at its lowermost position pressing down the band-shaped metal plate against the die plate in an example embodiment of the present invention.

FIG. 9 is an exemplary graph illustrating the relationship between the position of an upper mold in an up-down direction and the state of each component in an example embodiment of the present invention.

FIG. 10 is a flow chart illustrating a laminated iron core manufacturing method according to an example embodiment of the present invention.

### DETAILED DESCRIPTION OF THE EXAMPLE EMBODIMENTS

Example embodiments of laminated iron core manufacturing apparatuses according to the present invention will be described below with reference to the drawings. The example embodiments described below are limiting of the present invention in any way. Components and elements similar in function will be identified by common reference signs and, where appropriate, their description will be omitted or simplified to avoid redundancy.

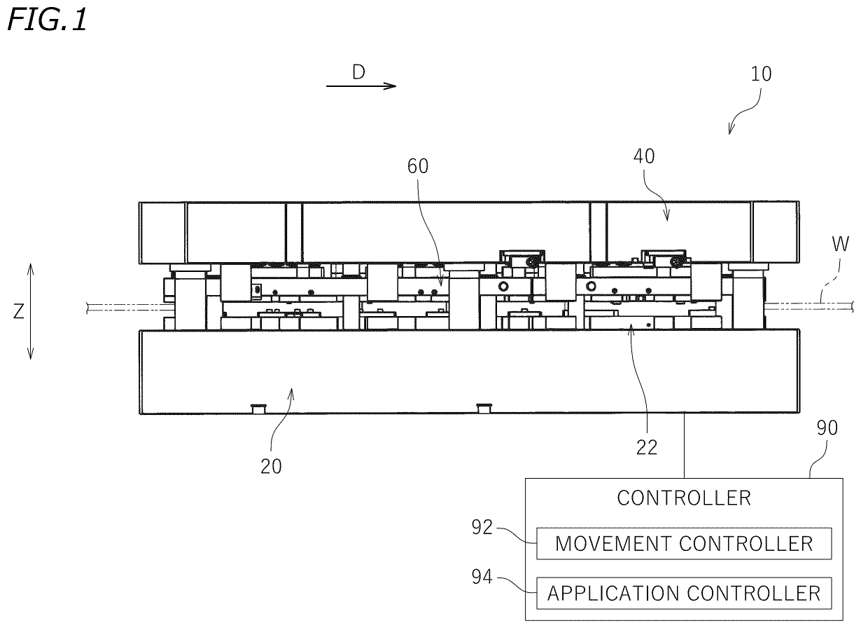

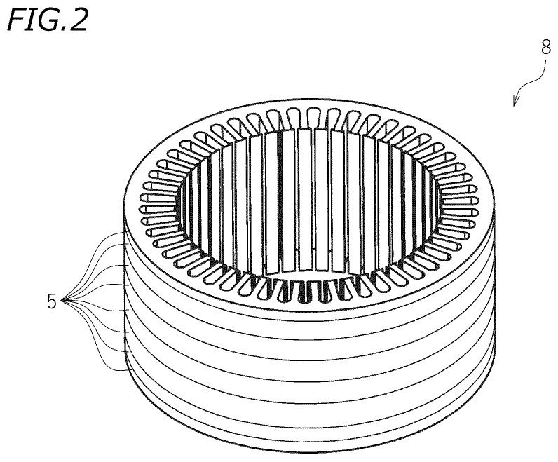

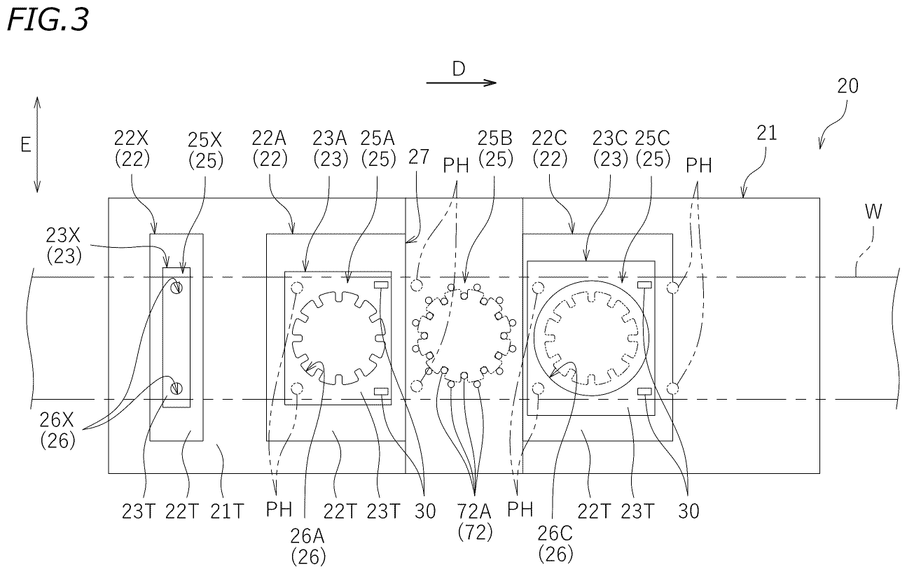

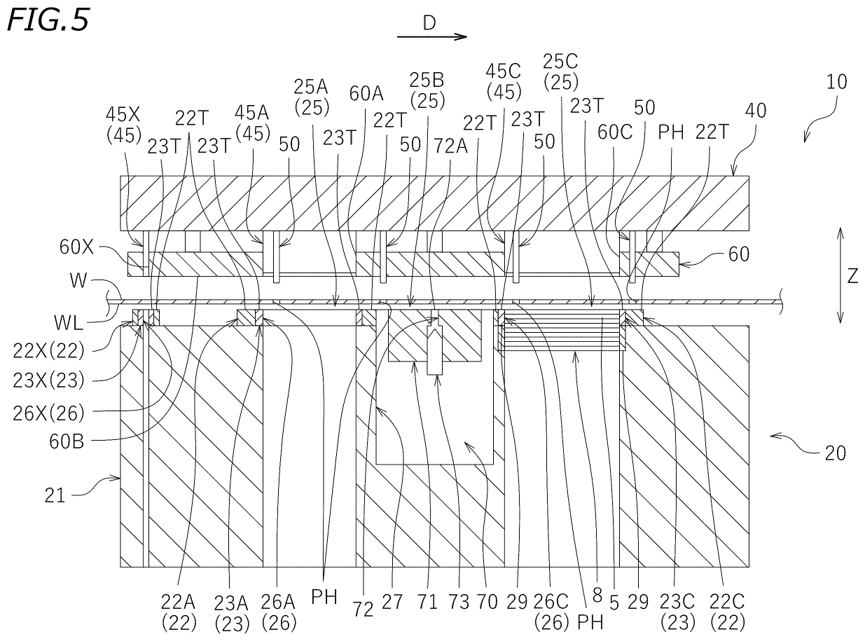

As illustrated in FIG. 1, a laminated iron core manufacturing apparatus 10 (hereinafter referred to as a “manufacturing apparatus 10”) according to the present example embodiment manufactures a laminated iron core 8 (see FIG. 2) including iron cores 5 (see FIG. 2) laminated and bonded together. The manufacturing apparatus 10 is a progressive press mold. The manufacturing apparatus 10 intermittently conveys a band-shaped metal plate W to machining stages 25 (see FIG. 3), which will be described below. The band-shaped metal plate W is, for example, is a coiled material (which is obtained from a band-shaped thin steel plate). The manufacturing apparatus 10 includes a lower mold 20, an upper mold 40, pilot pins 50 (see FIG. 5), a stripper plate 60, an adhesive applicator 70 (see FIG. 5), and a controller 90.

The lower mold 20 is fixed to a floor surface. As illustrated in FIG. 3, the lower mold 20 is provided with the machining stages 25. The machining stages 25 include a pilot hole punching stage 25X, an inner shape punching stage 25A, an adhesive applying stage 25B, and an outer shape punching stage 25C. The pilot hole punching stage 25X, the inner shape punching stage 25A, the adhesive applying stage 25B, and the outer shape punching stage 25C are arranged in this order in a progressive direction D (which is an example of a conveyance direction). The pilot hole punching stage 25X includes a pilot hole forming die plate 22X, a pilot hole forming die 23X, pilot hole punching die holes 26X, and pilot hole punches 45X (see FIG. 5), which will be described below. The inner shape punching stage 25A includes a first die plate 22A, a first die 23A, an inner shape punching die hole 26A, and an inner shape punch 45A (see FIG. 5), which will be described below. The outer shape punching stage 25C includes a second die plate 22C, a second die 23C, an outer shape punching die hole 26C, and an outer shape punch 45C (see FIG. 5), which will be described below.

The lower mold 20 includes a lower mold body 21, a die plate assembly 22, and a die assembly 23. The die plate assembly 22 and the die assembly 23 are placed on the lower mold body 21. The die plate assembly 22 holds the die assembly 23. The die plate assembly 22 includes the pilot hole forming die plate 22X holding the pilot hole forming die 23X (which will be described below), the first die plate 22A holding the first die 23A (which will be described below), and the second die plate 22C holding the second die 23C (which will be described below). The die assembly 23 includes the pilot hole forming die 23X included in the pilot hole punching stage 25X, the first die 23A included in the inner shape punching stage 25A, and the second die 23C included in the outer shape punching stage 25C. The die assembly 23 is provided with a die hole assembly 26. The pilot hole forming die 23X is provided with the pilot hole punching die holes 26X included in the die hole assembly 26. The first die 23A is provided with the inner shape punching die hole 26A included in the die hole assembly 26. The second die 23C is provided with the outer shape punching die hole 26C included in the die hole assembly 26. An upper surface 22T of the die plate assembly 22 and an upper surface 23T of the die assembly 23 are level with each other. More specifically, the upper surface 22T of the pilot hole forming die plate 22X and the upper surface 23T of the pilot hole forming die 23X are level with each other, the upper surface 22T of the first die plate 22A and the upper surface 23T of the first die 23A are level with each other, and the upper surface 22T of the second die plate 22C and the upper surface 23T of the second die 23C are level with each other. The lower mold body 21 includes the adhesive applying stage 25B. The lower mold body 21 is provided with an adhesive application through hole 27. The adhesive applicator 70 (see FIG. 5) is not illustrated in FIG. 3.

The band-shaped metal plate W is intermittently conveyed to the lower mold 20 by a conveyor (not illustrated) disposed adjacent to the manufacturing apparatus 10. The band-shaped metal plate W is intermittently conveyed to the pilot hole punching stage 25X, the inner shape punching stage 25A, the adhesive applying stage 25B, and the outer shape punching stage 25C in this order. The conveyor holds the band-shaped metal plate W in a wound state. The band-shaped metal plate W is conveyed to the lower mold 20 by an unwinder (not illustrated) of the conveyor. An offcut of the band-shaped metal plate W that has undergone pressing is conveyed from the lower mold 20 by a winder (not illustrated) of the conveyor and wound by the winder. Instead of being conveyed by the unwinder and winder of the conveyor, the band-shaped metal plate W may be conveyed by being sandwiched between one pair of upper and lower revolving rollers upstream of the manufacturing apparatus 10 and between another pair of upper and lower revolving rollers downstream of the manufacturing apparatus 10.

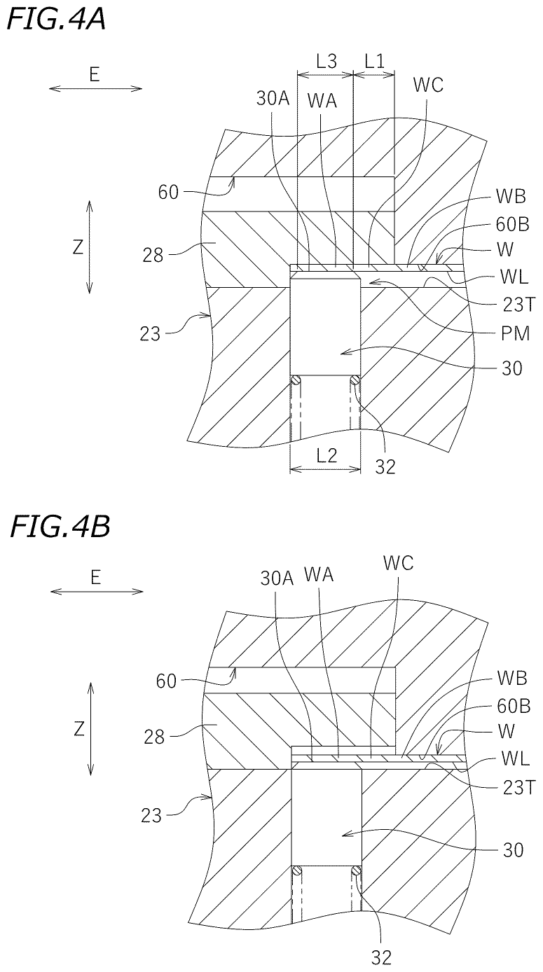

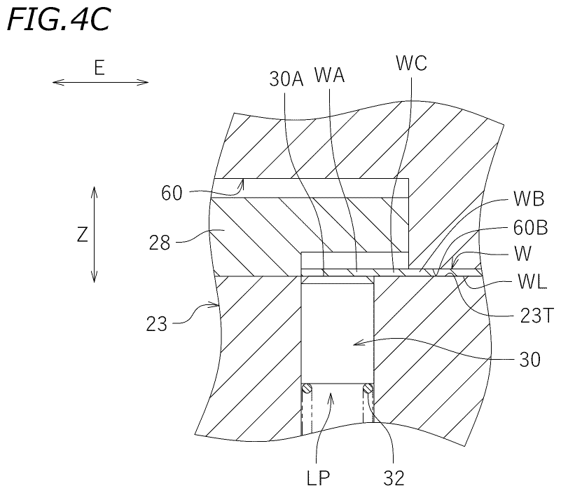

As illustrated in FIG. 3, the die assembly 23 of the lower mold 20 includes lifters 30. The lifters 30 urge the band-shaped metal plate W upward. The lifters 30 are configured to push the band-shaped metal plate W upward. During intermittent conveyance of the band-shaped metal plate W over the die plate assembly 22 and the die assembly 23, the lifters 30 push the band-shaped metal plate W upward so as to hold the band-shaped metal plate W such that the band-shaped metal plate W is located above the upper surface 22T of the die plate assembly 22 and the upper surface 23T of the die assembly 23 by a predetermined distance. As illustrated in FIG. 4A, each lifter 30 is urged upward by an urging member 32 provided in the die assembly 23. The urging member 32 is, for example, a coil spring. As illustrated in FIG. 4B, when the band-shaped metal plate W is pressed downward by the stripper plate 60 upon downward movement of the stripper plate 60, each lifter 30 is moved downward against an urging force of the urging member 32. Thus, the band-shaped metal plate W is pressed down against the upper surface 22T of the die plate assembly 22 of the lower mold 20 (or more specifically, the upper surface 22T of the pilot hole forming die plate 22X, the upper surface 22T of the first die plate 22A, and the upper surface 22T of the second die plate 22C) and against the upper surface 23T of the die assembly 23 (or more specifically, the upper surface 23T of the pilot hole forming die 23X, the upper surface 23T of the first die 23A, and the upper surface 23T of the second die 23C) by the stripper plate 60 (see FIG. 4C). At this point, the stripper plate 60 is located at its lowermost position LP. As illustrated in FIGS. 4A to 4C, the urging member 32 is configured to, during a period in which the stripper plate 60 pushes the metal plate W downward against the urging force of the urging member 32, allow a portion WC of the metal plate W (which is located between a portion WA of the metal plate W in contact with the lifter 30 and a portion WB of the metal plate W in contact with the stripper plate 60) to move downward while remaining horizontal. Specifically, the portion WA, the portion WB, and the portion WC move downward while remaining horizontal. In a width direction E perpendicular, in a plan view, to the progressive direction D in which the metal plate W is to be conveyed, a length L1 of the portion WC of the metal plate W (which is located between the portion WA of the metal plate W in contact with the lifter 30 and the portion WB of the metal plate W in contact with the stripper plate 60) is greater than or equal to one-half of a length L2 of the lifter 30. In the width direction E, the length L1 of the portion WC of the metal plate W (which is located between the portion WA of the metal plate W in contact with the lifter 30 and the portion WB of the metal plate W in contact with the stripper plate 60) is greater than or equal to one-half of a length L3 of a portion of the lifter 30 that is able to come into contact with the metal plate W. In the present example embodiment, the portion of each lifter 30 that is able to come into contact with the metal plate W has a linear shape in a side view. Alternatively, this portion may be arc-shaped. When the stripper plate 60 applies no pressing force to the band-shaped metal plate W upon upward movement of the stripper plate 60, each lifter 30 is moved upward by the urging force of the urging member 32. Specifically, each lifter 30 is configured to be movable to its uppermost position PM (see FIG. 4A) when the stripper plate 60 does not press the band-shaped metal plate W. Thus, the lifters 30 hold the band-shaped metal plate W at a predetermined height above the lower mold 20 (or more specifically, the upper surface 22T of the die plate assembly 22 and the upper surface 23T of the die assembly 23). In the course of being conveyed intermittently, the band-shaped metal plate W moves over an upper surface 30A of each lifter 30. The die assembly 23 of the lower mold 20 includes a restrictor 28 to restrict upward movement of the band-shaped metal plate W when the band-shaped metal plate W is pushed upward by the lifters 30. The restrictor 28 restricts an interval between the band-shaped metal plate W and the lower mold 20 (or more specifically, the upper surface 22T of the die plate assembly 22 and the upper surface 23T of the die assembly 23) from expanding to or beyond a predetermined range.

As illustrated in FIG. 5, the upper mold 40 is disposed over the lower mold 20. The upper mold 40 is configured to be movable toward and away from the lower mold 20. The upper mold 40 includes punches 45 conforming to the die hole assembly 26. The punches 45 include the pilot hole punches 45X, the inner shape punch 45A, and the outer shape punch 45C. Each pilot hole punch 45X is located over the associated pilot hole punching die hole 26X. Each pilot hole punch 45X is configured to be insertable through the associated pilot hole punching die hole 26X. The pilot hole punches 45X, the number of which is two, are arranged side by side at a predetermined interval in the width direction E (see FIG. 3) perpendicular to the progressive direction D. The inner shape punch 45A is located over the inner shape punching die hole 26A. The inner shape punch 45A is configured to be insertable through the inner shape punching die hole 26A. The outer shape punch 45C is located over the outer shape punching die hole 26C. The outer shape punch 45C is configured to be insertable through the outer shape punching die hole 26C. In the pilot hole punching stage 25X, the upper mold 40 is lowered toward the lower mold 20, and then the band-shaped metal plate W is punched using the pilot hole punches 45X and the pilot hole punching die holes 26X. Thus, the pilot holes PH (see FIG. 3) are formed in the band-shaped metal plate W. As illustrated in FIG. 3, the number of pilot holes PH formed is two, and the two pilot holes PH are arranged in the width direction E, for example. The pilot pins 50 are to be inserted through the pilot holes PH. As illustrated in FIG. 5, in the inner shape punching stage 25A (see FIG. 3), the upper mold 40 is lowered toward the lower mold 20, and then the band-shaped metal plate W is punched using the inner shape punch 45A and the inner shape punching die hole 26A. Thus, the inner shape of the iron core 5 is formed in the band-shaped metal plate W. In the outer shape punching stage 25C (see FIG. 3), the upper mold 40 is lowered toward the lower mold 20, and then the band-shaped metal plate W is punched using the outer shape punch 45C and the outer shape punching die hole 26C. Thus, the outer shape of the iron core 5 is formed in the band-shaped metal plate W. This completes the iron core 5 (see also FIG. 2). The iron cores 5 are sequentially laminated inside the outer shape punching die hole 26C. As will be described below, an adhesive is applied to a lower surface of each iron core 5 completed. Accordingly, the iron cores 5 laminated in an up-down direction Z are bonded together.

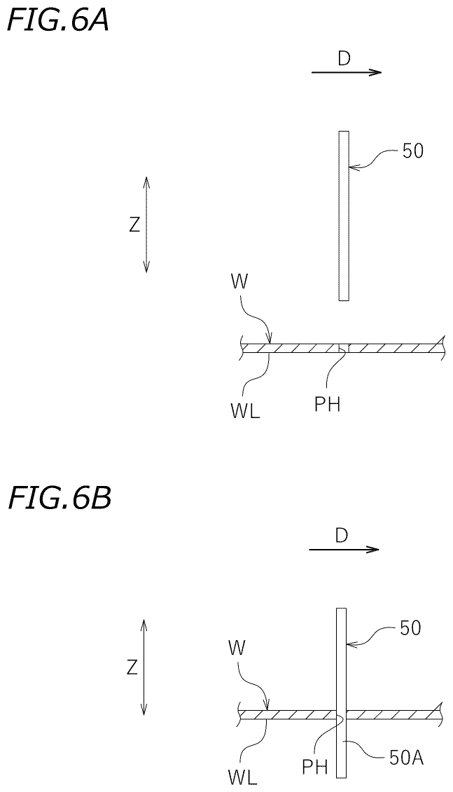

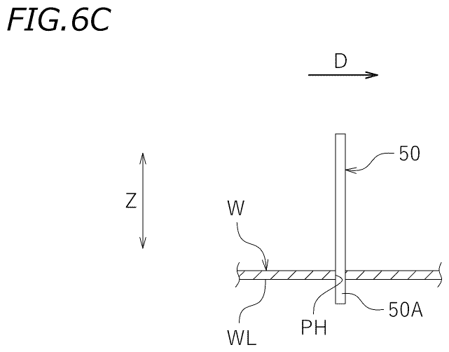

As illustrated in FIG. 5, the pilot pins 50 are provided on the upper mold 40. As illustrated in FIG. 6A, each pilot pin 50 is disposed to face the associated pilot hole PH formed in the band-shaped metal plate W. Each pilot pin 50 is configured to be movable in the up-down direction Z together with the upper mold 40. Each pilot pin 50 is configured to be insertable through the associated pilot hole PH. As illustrated in FIG. 6B, lowering the upper mold 40 inserts each pilot pin 50 through the associated pilot hole PH. The insertion of the pilot pins 50 through the pilot holes PH determines the positioning of the band-shaped metal plate W with respect to the manufacturing apparatus 10 (e.g., the adhesive applicator 70). FIG. 6B illustrates the pilot pin 50 located at its lowermost position, i.e., the pilot pin 50 located at its bottom dead point. When the upper mold 40 is located at its bottom dead point, each pilot pin 50 is located at its bottom dead point. As illustrated in FIG. 6B, each pilot pin 50 includes an insertion portion 50A to be inserted through the associated pilot hole PH. The insertion portion 50A is a portion of each pilot pin 50 located under the associated pilot hole PH when the pilot pin 50 is located at its bottom dead point. With each pilot pin 50 inserted through the associated pilot hole PH, raising the upper mold 40 removes each pilot pin 50 from the associated pilot hole PH. FIG. 6C illustrates one-half of the insertion portion 50A of each pilot pin 50 (as measured along the up-down direction Z) being inserted through the associated pilot hole PH. In FIGS. 6A to 6C, the upper mold 40 and other components are not illustrated for the sake of convenience of description.

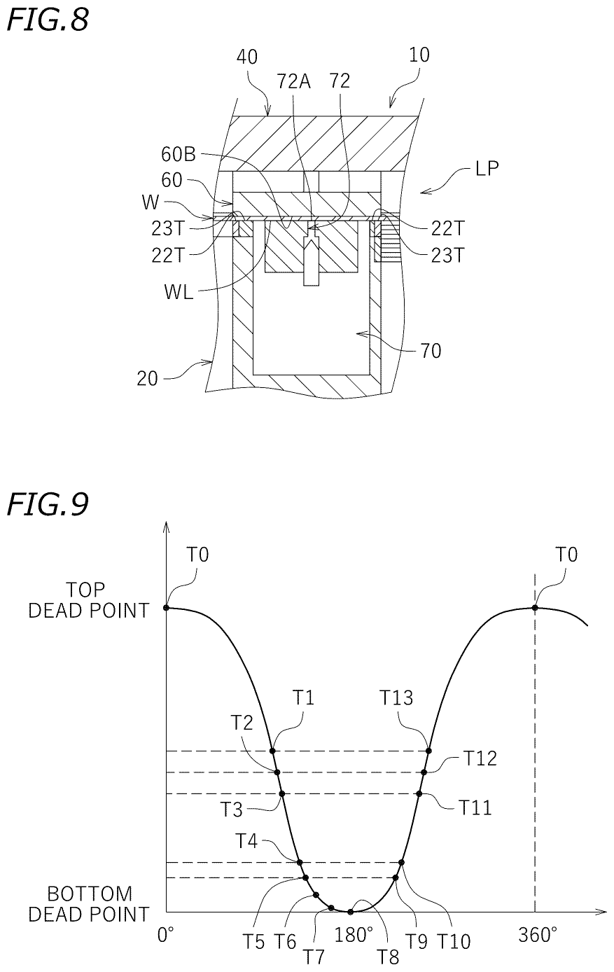

As illustrated in FIG. 5, the stripper plate 60 is provided on the upper mold 40. The stripper plate 60 is disposed to face the die plate assembly 22 of the lower mold 20. The stripper plate 60 is configured to be movable in the up-down direction together with the upper mold 40. The stripper plate 60 is configured to be movable downward to the lowermost position LP (see FIG. 8), which is the lowest possible position of the stripper plate 60. When the band-shaped metal plate W is punched with the punches 45, the stripper plate 60 located at the lowermost position LP is able to restrict movement of the metal plate W in the up-down direction. The stripper plate 60 located slightly above the lowermost position LP is also able to restrict movement of the metal plate W in the up-down direction Z. The stripper plate 60 is configured to, upon moving to the lowermost position LP, press down the band-shaped metal plate W, which is conveyed intermittently, against the lower mold 20 (i.e., the die plate assembly 22 and the die assembly 23) such that the band-shaped metal plate W is allowed to be sandwiched between the stripper plate 60 and the lower mold 20 (i.e., the die plate assembly 22 and the die assembly 23). The stripper plate 60 presses down the band-shaped metal plate W against the upper surface 22T of the die plate assembly 22 and the upper surface 23T of the die assembly 23. The stripper plate 60 is provided with punch insertion holes 60X through which the pilot hole punches 45X are to be inserted, a punch insertion hole 60A through which the inner shape punch 45A is to be inserted, and a punch insertion hole 60C through which the outer shape punch 45C is to be inserted. The upper mold 40 is lowered such that the stripper plate 60 presses down the band-shaped metal plate W against the die plate assembly 22. In this state, upon further lowering of the upper mold 40, the pilot hole punches 45X protrude from the punch insertion holes 60X and are inserted through the pilot hole punching die holes 26X, the inner shape punch 45A protrudes from the punch insertion hole 60A and is inserted through the inner shape punching die hole 26A, and the outer shape punch 45C protrudes from the punch insertion hole 60C and is inserted through the outer shape punching die hole 26C.

As illustrated in FIG. 3, the adhesive applicator 70 is provided in the lower mold body 21 of the lower mold 20. The adhesive applicator 70 is disposed between the inner shape punching stage 25A and the outer shape punching stage 25C. In the present example embodiment, the sentence “the adhesive applicator 70 is disposed between the inner shape punching stage 25A and the outer shape punching stage 25C” includes the situation where the adhesive applicator 70 adjoins the inner shape punching stage 25A (e.g., the situation where the adhesive applicator 70 is provided on the first die plate 22A) and the situation where the adhesive applicator 70 adjoins the outer shape punching stage 25C (e.g., the situation where the adhesive applicator 70 is provided on the second die plate 22C). The adhesive applicator 70 does not necessarily have to be disposed between the inner shape punching stage 25A and the outer shape punching stage 25C. In one example, the adhesive applicator 70 may adjoin the pilot hole punching stage 25X. In the example of FIG. 3, nozzles 72 of the adhesive applicator 70 are illustrated. The nozzles 72 are disposed at substantially equal intervals along two concentric rings. The adhesive applicator 70 is provided in the adhesive applying stage 25B (see also FIG. 5). More specifically, the adhesive applicator 70 is disposed inside the adhesive application through hole 27. The adhesive applicator 70 is located below the band-shaped metal plate W. The adhesive applicator 70 applies an adhesive to a lower surface WL of the band-shaped metal plate W. The adhesive applicator 70 applies the adhesive to the lower surface WL of the band-shaped metal plate W in the course of conveyance of the band-shaped metal plate W from the inner shape punching stage 25A to the outer shape punching stage 25C. The adhesive applicator 70 according to the present example embodiment applies the adhesive to the lower surface WL of the band-shaped metal plate W using a non-contact application process (e.g., a jet-dispensing process or a spraying process). Examples of liquid adhesives for application by the adhesive applicator 70 include an epoxy adhesive, an acrylic adhesive, a silicon adhesive, and a urethane adhesive. Any adhesive with sufficient adhesive strength to form the laminated iron core 8 may be used. The adhesive may be cured by any method. Examples of adhesive curing methods include solvent vaporization, moisture curing, heat curing, and mixing curing agents.

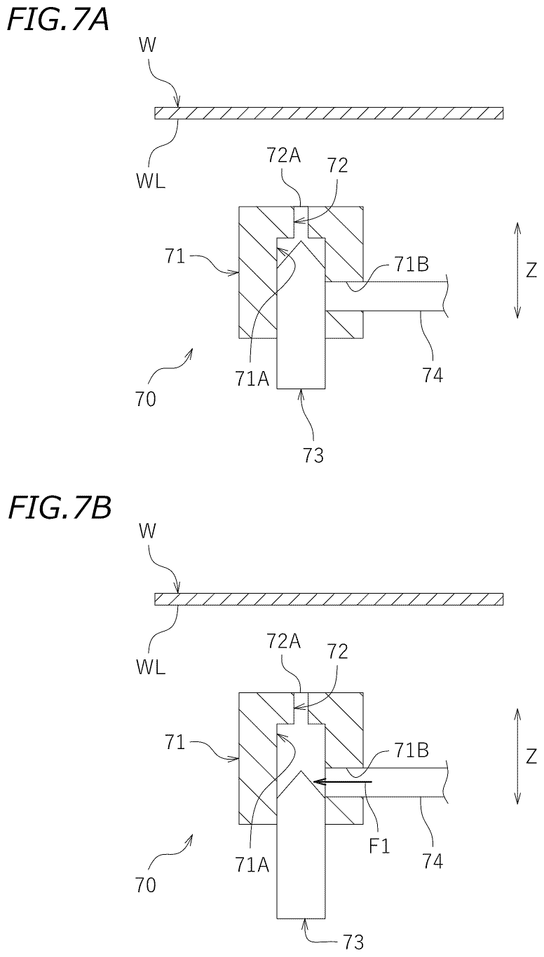

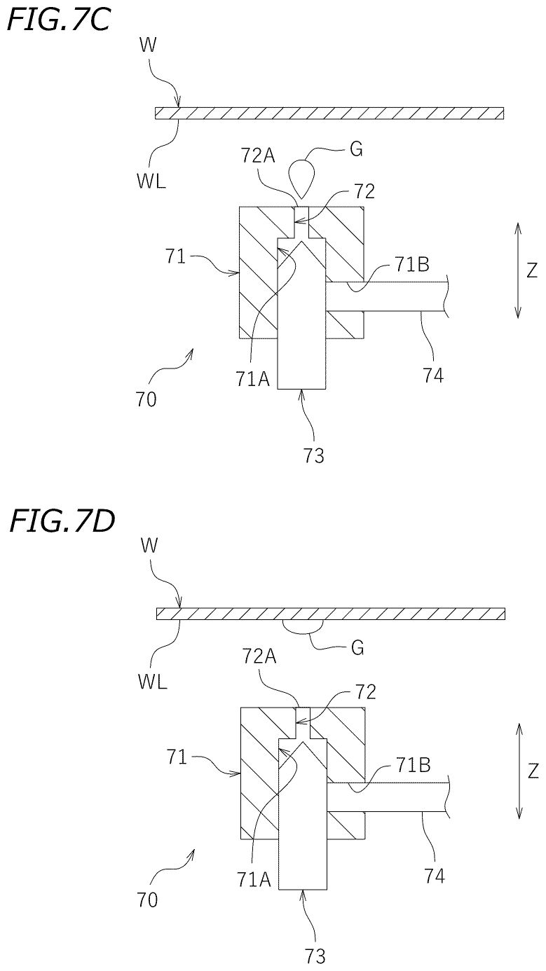

As illustrated in FIGS. 7A to 7D, the adhesive applicator 70 includes a housing 71, the nozzles 72, a plunger 73, and a feeding tube 74. The housing 71 includes an adhesive container 71A to be filled with the adhesive. The housing 71 includes an insertion hole 71B through which the feeding tube 74 is inserted. The adhesive container 71A and the insertion hole 71B are in communication with each other. Each nozzle 72 is provided in the housing 71. Each nozzle 72 is in communication with the adhesive container 71A. Each nozzle 72 is located below the band-shaped metal plate W. A discharge port 72A of each nozzle 72 is located below the upper surface 22T of the die plate assembly 22 and the upper surface 23T of the die assembly 23, which define the uppermost surface of the lower mold 20 (see FIG. 5). Each nozzle 72 sprays the adhesive onto the lower surface WL of the band-shaped metal plate W. The adhesive sprayed from the discharge port 72A of each nozzle 72 becomes a droplet that is then applied to the lower surface WL of the band-shaped metal plate W. A portion of the plunger 73 is accommodated in the adhesive container 71A of the housing. The plunger 73 slides inside the adhesive container 71A. The plunger 73 is configured to open and close the insertion hole 71B. The feeding tube 74 is inserted through the insertion hole 71B. The feeding tube 74 is connected to an adhesive containing tank (not illustrated) that contains the adhesive. In one example, an application controller 94 (FIG. 1) of the controller 90, which will be described in more detail below, actuates a feeding pump (not illustrated) so as to feed the adhesive to the adhesive container 71A through the feeding tube 74.

As illustrated in FIG. 7A, the major portion of the plunger 73 is accommodated in the adhesive container 71A during non-operation of the adhesive applicator 70. During this period, the insertion hole 71B is closed with the plunger 73, which brings the adhesive container 71A out of communication with the insertion hole 71B, with the result that no adhesive is fed to the adhesive container 71A. As illustrated in FIG. 7B, upon reception of a signal by the adhesive applicator 70, the plunger 73 moves downward so as to open the insertion hole 71B, bringing the adhesive container 71A into communication with the insertion hole 71B. The adhesive is thus fed to the adhesive container 71A through the feeding tube 74 as indicated by an arrow F1. As illustrated in FIG. 7C, upon completion of filling of the adhesive container 71A with the adhesive, the plunger 73 moves upward. As a result, an adhesive G contained in the adhesive container 71A is discharged (or sprayed) from each nozzle 72. At this point, the plunger 73 closes the insertion hole 71B. As illustrated in FIG. 7D, the adhesive G discharged (or sprayed) from each nozzle 72 is applied to the lower surface WL of the band-shaped metal plate W, with the result that the adhesive G adheres to the lower surface WL. The adhesive G that has been sprayed from the discharge port 72A of each nozzle 72 and has become a droplet spreads over a range wider than an opening area of the discharge port 72A when the adhesive G is applied to (or adheres to) the lower surface WL of the band-shaped metal plate W.

The adhesive applicator 70 applies the adhesive to the lower surface WL of the band-shaped metal plate W using a non-contact application process. The adhesive applicator 70, however, may apply the adhesive to the lower surface WL using any other method. The adhesive applicator 70 may apply the adhesive to the lower surface WL of the band-shaped metal plate W using a contact application process. In one example, the adhesive applicator 70 may bring the adhesive bulging from the discharge port 72A of each nozzle 72 into contact with the band-shaped metal plate W so as to transfer the adhesive to the lower surface WL.

FIG. 9 is an exemplary graph illustrating the relationship between the position of the upper mold 40 in the up-down direction Z and the state of each component during one cycle in which the upper mold 40 located at its top dead point passes through its bottom dead point and then returns to its top dead point again. The relationship between the position of the upper mold 40 in the up-down direction Z and the state of each component is not limited to that illustrated in FIG. 9. The vertical axis in FIG. 9 represents the position of the upper mold 40 in the up-down direction Z. The horizontal axis in FIG. 9 represents the angle (or crank angle) of the upper mold 40.

As illustrated in FIG. 9, at a timing T0 when the upper mold 40 is located at the top dead point, the band-shaped metal plate W is being conveyed in the progressive direction D. When the upper mold 40 moves downward and a timing T1 is reached, the conveyance of the band-shaped metal plate W is finished. Specifically, the conveyance of the band-shaped metal plate W is stopped between the timing T1 and a timing T13 (which will be described below). When the upper mold 40 moves further downward and a timing T2 is reached, the pilot pins 50 start being inserted through the pilot holes PH formed in the band-shaped metal plate W. In other words, the pilot pins 50 are not inserted through the pilot holes PH before the timing T2. When the upper mold 40 moves further downward and a timing T3 is reached, the stripper plate 60 comes into contact with the metal plate W. At the timing T3, the stripper plate 60 starts pressing the lifters 30 downward through the metal plate W, causing the lifters 30 to start moving downward. When the timing T3 is reached, the adhesive applicator 70 may start applying the adhesive to the lower surface WL of the metal plate W. When the upper mold 40 moves further downward and a timing T4 is reached, the stripper plate 60 moves to the lowermost position LP so as to press down the metal plate W against the lower mold 20. At this point, the lifters 30 finish moving downward and are located at their lowermost positions. When the upper mold 40 moves further downward and a timing T5 is reached, the adhesive applicator 70 may start applying the adhesive to the lower surface WL of the metal plate W. When the upper mold 40 moves further downward and a timing T6 is reached, the metal plate W starts being punched with the pilot hole punches 45X, the inner shape punch 45A, and the outer shape punch 45C. When the upper mold 40 moves further downward and a timing T7 is reached, the metal plate W finishes being punched with the pilot hole punches 45X, the inner shape punch 45A, and the outer shape punch 45C. The upper mold 40 then passes through the bottom dead point at a timing T8 and starts moving upward.

As illustrated in FIG. 9, when the upper mold 40 moves upward from the bottom dead point and a timing T9 is reached, the application of the adhesive may be finished if the adhesive applicator 70 has started applying the adhesive to the lower surface WL of the metal plate W using a non-contact application process at the timing T3 or timing T5. When the upper mold 40 moves further upward and a timing T10 is reached, the stripper plate 60 finishes pressing down the metal plate W, and each lifter 30 starts being raised by the urging member 32. When the upper mold 40 moves further upward and a timing T11 is reached, the stripper plate 60 moves completely away from the metal plate W, and each lifter 30 moves to the uppermost position PM (see FIG. 4A). The application of the adhesive is finished at the timing T11 if the adhesive applicator 70 has started applying the adhesive to the lower surface WL of the metal plate W at the timing T3 or timing T5 and the application of the adhesive has not been finished at the timing T9. As just described, if the adhesive is applied using a non-contact application process, the application of the adhesive is finished at the timing T9 or timing T11. If the adhesive is applied using a contact application process, the application of the adhesive is finished at the timing T11. When the upper mold 40 moves further upward and a timing T12 is reached, the pilot pins 50 that have been inserted through the pilot holes PH are completely removed from the pilot holes PH. At least portions of the pilot pins 50 are inserted through in the pilot holes PH between the timing T2 and the timing T12. When the upper mold 40 moves further upward and the timing T13 is reached, the conveyance of the band-shaped metal plate W starts. Specifically, the band-shaped metal plate W is conveyed in the progressive direction D between the timing T13 and the timing T1. At the timing T0, the upper mold 40 passes through the top dead point and then starts moving downward.

As illustrated in FIG. 1, the controller 90 is configured or programmed to control the upper mold 40 and the adhesive applicator 70. In one example, the controller 90 may include a central processing unit (CPU) to execute commands included in a control program, a ROM storing the program to be executed by the CPU, a RAM for use as a working area where the program is to be decompressed, and a storage device, such as a memory, to store the program and/or various data. The controller 90 is configured or programmed to include a movement controller 92 and the application controller 94. The functions of the components of the controller 90 may be implemented by program(s). The program(s) is/are downloaded, for example, via the Internet. The program(s) may be read from, for example, a storage medium, such as a CD or a DVD. The functions of the components of the controller 90 may be implementable by, for example, processor(s) and/or circuit(s).

The movement controller 92 is configured or programmed to control movement of the stripper plate 60 in the up-down direction Z. In the present example embodiment, the movement controller 92 moves the upper mold 40 in the up-down direction Z so as to control movement of the pilot pins 50 and the stripper plate 60 in the up-down direction Z. The movement controller 92 is configured or programmed to control movement of the upper mold 40 toward and away from the lower mold 20. The movement controller 92 may be configured or programmed to change the raising and lowering speeds of the upper mold 40. The movement controller 92 may be configured or programmed to change the lowermost position LP in accordance with the thickness of the metal plate W. Specifically, the movement controller 92 may be configured or programmed to adjust the interval between a lower surface 60B of the stripper plate 60 at the lowermost position LP and the upper surface 22T of the die plate assembly 22 in accordance with the thickness of the metal plate W.

The application controller 94 is configured or programmed to control the adhesive applicator 70. The application controller 94 is configured or programmed to control movement of the plunger 73. The application controller 94 is configured or programmed to cause the adhesive applicator 70 to start applying the adhesive to the lower surface WL of the metal plate W after the pilot pins 50 have been inserted through the pilot holes PH (e.g., after the timing T2 in FIG. 9). The application controller 94 may be configured or programmed to cause the adhesive applicator 70 to start applying the adhesive to the lower surface WL of the metal plate W only while at least portions of the pilot pins 50 are inserted through the pilot holes PH (e.g., between the timing T2 and the timing T5 in FIG. 9). The application controller 94 may be configured or programmed to cause the adhesive applicator 70 to finish applying the adhesive to the lower surface WL of the metal plate W before the pilot pins 50 are removed from the pilot holes PH (e.g., before the timing T12 in FIG. 9). The application controller 94 may be configured or programmed to cause the adhesive applicator 70 to finish applying the adhesive to the lower surface WL of the metal plate W at some point between a time at which the pilot pins 50 are located at their bottom dead points, i.e., at which the upper mold 40 is located at its bottom dead point (see FIG. 6B), and a time before the pilot pins 50 are moved upward from their bottom dead points and removed from the pilot holes PH (e.g., at some point between the timing T8 and the timing T12 in FIG. 9). The application controller 94 may cause the adhesive applicator 70 to finish applying the adhesive to the lower surface WL of the metal plate W at some point between a time at which one-half of the insertion portion 50A of each pilot pin 50 as measured along the up-down direction Z is removed from the associated pilot hole PH (see FIG. 6C) and a time before an entirety of the insertion portion 50A of each pilot pin 50 is removed from the associated pilot hole PH (e.g., before the timing T12 in FIG. 9). The application controller 94 may cause the adhesive applicator 70 to finish applying the adhesive to the lower surface WL of the metal plate W before each lifter 30 reaches the uppermost position PM (see FIG. 4A), e.g., before the timing T11 in FIG. 9. The application controller 94 may cause the adhesive applicator 70 to apply the adhesive to the lower surface WL of the metal plate W only while the conveyance of the metal plate W is stopped (e.g., between the timing T1 and the timing T13 in FIG. 9). The application controller 94 may cause the adhesive applicator 70 to apply the adhesive to the lower surface WL of the metal plate W only while at least portions of the pilot pins 50 are inserted through the pilot holes PH and the conveyance of the metal plate W is stopped (e.g., between the timing T2 and the timing T12 in FIG. 9).

The application controller 94 may be configured or programmed to change a start timing that is a timing when the adhesive applicator 70 starts applying the adhesive to the lower surface WL of the metal plate W. In the example illustrated in FIG. 9, the start timing corresponds to the timing T3 and the timing T5. As used herein, the term “timing” includes both of a timing based on a crank angle and a timing based on an elapsed time. The application controller 94 may be configured or programmed to change the start timing in accordance with the amount of adhesive to be applied per application area of the lower surface WL of the metal plate W (i.e., the necessary amount of adhesive to be applied to bond the iron cores 5 together). The application controller 94 may be configured or programmed to delay the start timing as the amount of adhesive to be applied per application area decreases. Due to clogging of the nozzles 72, for example, a difference may occur between the amount of adhesive that should be applied (i.e., the amount of adhesive to be applied) and the amount of adhesive actually applied. Specifically, the amount of adhesive actually applied may be smaller than the amount of adhesive to be applied. With the provision of a sensor to measure the amount of adhesive actually applied, the application controller 94 may be configured or programmed to change the start timing in accordance with the amount of adhesive actually applied per application area of the lower surface WL of the metal plate W. The application controller 94 may be configured or programmed to change the start timing in accordance with the viscosity of the adhesive (which, in this example embodiment, includes the temperature of the apparatus itself and an ambient temperature that affect the viscosity of the adhesive). In one example, the manufacturing apparatus 10 may include a sensor to measure the viscosity of the adhesive, and the application controller 94 may be configured or programmed to change the start timing in accordance with the viscosity of the adhesive measured by the sensor. The application controller 94 may be configured or programmed to advance the start timing as the viscosity of the adhesive increases. The start timing may be a timing when an adhesive spraying start signal is transmitted to the nozzles 72. The start timing may be a timing when spraying of the adhesive from the nozzles 72 starts. The start timing may be a timing when the adhesive applicator 70 starts transferring the adhesive to the lower surface WL of the metal plate W. The start timing may be a timing when the adhesive discharged upward from the discharge ports 72A of the nozzles 72 (e.g., the adhesive bulging upward from the discharge ports 72A) starts coming into contact with the lower surface WL of the metal plate W.

The application controller 94 may be configured or programmed to change a finish timing that is a timing when the adhesive applicator 70 finishes applying the adhesive to the lower surface WL of the metal plate W. In the example illustrated in FIG. 9, the finish timing corresponds to the timing T9 and the timing T11. The application controller 94 may be configured or programmed to change the finish timing in accordance with the amount of adhesive to be applied per application area of the lower surface WL of the metal plate W. The application controller 94 may be configured or programmed to advance the finish timing as the amount of adhesive to be applied per application area decreases. The application controller 94 may be configured or programmed to change the finish timing in accordance with the viscosity of the adhesive. The application controller 94 may be configured or programmed to delay the finish timing as the viscosity of the adhesive increases. The finish timing may be a timing when an adhesive spraying finish signal is transmitted to the nozzles 72. The finish timing may be a timing when spraying of the adhesive from the nozzles 72 is finished. The finish timing may be a timing when the adhesive applicator 70 finishes transferring the adhesive to the lower surface WL of the metal plate W. The finish timing may be a timing when the adhesive discharged upward from the discharge ports 72A of the nozzles 72 is transferred to the lower surface WL of the metal plate W and separated from the discharge ports 72A. At this timing, the adhesive may bulge upward from the discharge ports 72A.

The application controller 94 may be configured or programmed to change a time interval between the start and finish of application of the adhesive from the adhesive applicator 70 to the lower surface WL of the metal plate W. In the example illustrated in FIG. 9, the time interval corresponds to the interval between the timing T3 and the timing T11. The change in the time interval includes both of the situation where the crank angle between the start and finish of the adhesive application is changed and the situation where the time elapsed between the start and finish of the adhesive application is changed. In one example, if the crank angle between the start and finish of the adhesive application is constant, the time interval between the start and finish of the adhesive application may be changed by changing the raising speed (i.e., pressing speed) of the upper mold 40. The application controller 94 may be configured or programmed to change a time interval between the finish of application of the adhesive from the adhesive applicator 70 to the lower surface WL of the metal plate W and the removal of the pilot pins 50 from the pilot holes PH. The change in the time interval includes both of the situation where the crank angle between the finish of the adhesive application and the removal of the pilot pins 50 from the pilot holes PH is changed and the situation where the time elapsed between the finish of the adhesive application and the removal of the pilot pins 50 from the pilot holes PH is changed.

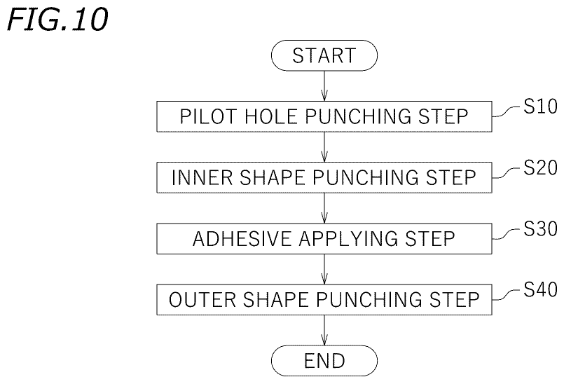

The following description discusses a non-limiting example of a method for manufacturing the laminated iron core 8. The method for manufacturing the laminated iron core 8 will be described below, focusing on one of the iron cores 5 included in the laminated iron core 8. FIG. 10 is a flow chart illustrating the method for manufacturing the laminated iron core 8. As illustrated in FIG. 10, the method for manufacturing the laminated iron core 8 includes a pilot hole punching step (step S10), an inner shape punching step (step S20), an adhesive applying step (step S30), and an outer shape punching step (step S40). The pilot hole punching step (step S10), the inner shape punching step (step S20), and the outer shape punching step (step S40) are concurrently performed on the band-shaped metal plate W.

In the pilot hole punching step (step S10), with the stripper plate 60 located at the lowermost position LP (see FIG. 8), the band-shaped metal plate W is punched with the pilot hole punches 45X so as to form the pilot holes PH in the metal plate W. More specifically, with further downward movement of the upper mold 40, the band-shaped metal plate W pressed down against the upper surface 22T of the die plate assembly 22 and the upper surface 23T of the die assembly 23 is punched using the pilot hole punches 45X and the pilot hole punching die holes 26X, with the result that the pilot holes PH are formed in the band-shaped metal plate W. In the pilot hole punching step (step S10), the band-shaped metal plate W is sandwiched between the stripper plate 60 and the die plate assembly 22 and die assembly 23.

In the inner shape punching step (step S20), with the stripper plate 60 located at the lowermost position LP, the band-shaped metal plate W is punched with the inner shape punch 45A so as to form the inner shape of the iron core 5. More specifically, with further downward movement of the upper mold 40, the band-shaped metal plate W pressed down against the upper surface 22T of the die plate assembly 22 and the upper surface 23T of the die assembly 23 is punched using the inner shape punch 45A and the inner shape punching die hole 26A, with the result that the inner shape of the iron core 5 is formed in the band-shaped metal plate W. In the inner shape punching step (step S20), the band-shaped metal plate W is sandwiched between the stripper plate 60 and the die plate assembly 22 and die assembly 23.

In the adhesive applying step (step S30), the adhesive applicator 70 applies (e.g., sprays) the adhesive to the lower surface WL of the band-shaped metal plate W. The adhesive applicator 70 is controlled by the application controller 94 such that the adhesive applicator 70 starts and finishes applying the adhesive at the timings described above.

In the outer shape punching step (step S40), with the stripper plate 60 located at the lowermost position LP, the band-shaped metal plate W is punched with the outer shape punch 45C so as to form the outer shape of the iron core 5. More specifically, with further downward movement of the upper mold 40, the band-shaped metal plate W pressed down against the upper surface 22T of the die plate assembly 22 and the upper surface 23T of the die assembly 23 is punched using the outer shape punch 45C and the outer shape punching die hole 26C, with the result that the outer shape of the iron core 5 is formed in the band-shaped metal plate W. The iron cores 5 formed are pressed by the outer shape punch 45C and sequentially laminated inside the outer shape punching die hole 26C. Because the adhesive is applied to the lower surface of each iron core 5 formed, the laminated iron core 8 including the iron cores 5 laminated in the up-down direction and bonded together is manufactured by sequentially laminating the iron cores 5, each placed on top of the previous one inside the outer shape punching die hole 26C. In step S40, the band-shaped metal plate W is sandwiched between the stripper plate 60 and the die plate assembly 22 and die assembly 23.

As described above, the laminated iron core manufacturing apparatus 10 according to the present example embodiment includes the controller 90 to control the upper mold 40 and the adhesive applicator 70. The application controller 94 of the controller 90 is configured or programmed to change the start timing, which is the timing when the adhesive applicator 70 starts applying the adhesive to the lower surface WL of the metal plate W. The above-described example embodiment is able to suitably change the timing to start the adhesive application. Accordingly, the above-described example embodiment is able to more accurately apply the adhesive to a predetermined position on the lower surface WL of the metal plate W at a predetermined timing.

In the laminated iron core manufacturing apparatus 10 according to the present example embodiment, the application controller 94 may be configured or programmed to change the start timing in accordance with the amount of adhesive to be applied per application area of the lower surface WL of the metal plate W. The above-described example embodiment is able to more accurately set the start timing.

In the laminated iron core manufacturing apparatus 10 according to the present example embodiment, the application controller 94 may be configured or programmed to delay the start timing as the amount of adhesive to be applied per application area decreases. The above-described example embodiment is able to more accurately apply the adhesive to the predetermined position on the lower surface WL of the metal plate W.

The laminated iron core manufacturing apparatus 10 according to the present example embodiment is able to more accurately set the start timing.

In the laminated iron core manufacturing apparatus 10 according to the present example embodiment, the application controller 94 may be configured or programmed to advance the start timing as the viscosity of the adhesive increases. The above-described example embodiment is able to more accurately apply the adhesive to the predetermined position on the lower surface WL of the metal plate W.

In the laminated iron core manufacturing apparatus 10 according to the present example embodiment, the start timing may be the timing when the adhesive spraying start signal is transmitted to the nozzles 72. The above-described example embodiment is able to more accurately set the start timing.

In the laminated iron core manufacturing apparatus 10 according to the present example embodiment, the start timing may be the timing when spraying of the adhesive from the nozzles 72 starts. The above-described example embodiment is able to more accurately set the start timing.

In the laminated iron core manufacturing apparatus 10 according to the present example embodiment, the start timing may be the timing when the adhesive applicator 70 starts transferring the adhesive to the lower surface WL of the metal plate W. The above-described example embodiment is able to more accurately set the start timing.

In the laminated iron core manufacturing apparatus 10 according to the present example embodiment, the start timing may be the timing when the adhesive discharged upward from the discharge ports 72A starts coming into contact with the lower surface WL of the metal plate W. The above-described example embodiment is able to more accurately set the start timing.

In the laminated iron core manufacturing apparatus 10 according to the present example embodiment, the application controller 94 may be configured or programmed to change the time interval between the start and finish of application of the adhesive from the adhesive applicator 70 to the lower surface WL of the metal plate W. The above-described example embodiment is able to more accurately apply the adhesive to the predetermined position on the lower surface WL of the metal plate W at the predetermined timing.

In the laminated iron core manufacturing apparatus 10 according to the present example embodiment, the application controller 94 may be configured or programmed to change the finish timing, which is the timing when the adhesive applicator 70 finishes applying the adhesive to the lower surface WL of the metal plate W. The above-described example embodiment is able to suitably change the timing for finishing the adhesive application. Accordingly, the above-described example embodiment is able to more accurately apply the adhesive to the predetermined position on the lower surface WL of the metal plate W at the predetermined timing.

In the laminated iron core manufacturing apparatus 10 according to the present example embodiment, the application controller 94 may be configured or programmed to change the finish timing in accordance with the amount of adhesive to be applied per application area of the lower surface WL of the metal plate W. The above-described example embodiment is able to more accurately set the finish timing.

In the laminated iron core manufacturing apparatus 10 according to the present example embodiment, the application controller 94 may be configured or programmed to advance the finish timing as the amount of adhesive to be applied per application area decreases. The above-described example embodiment is able to more accurately apply the adhesive to the predetermined position on the lower surface WL of the metal plate W.

In the laminated iron core manufacturing apparatus 10 according to the present example embodiment, the application controller 94 may be configured or programmed to change the finish timing in accordance with the viscosity of the adhesive. The above-described example embodiment is able to more accurately set the finish timing.

In the laminated iron core manufacturing apparatus 10 according to the present example embodiment, the application controller 94 may be configured or programmed to delay the finish timing as the viscosity of the adhesive increases. The above-described example embodiment is able to more accurately apply the adhesive to the predetermined position on the lower surface WL of the metal plate W.

In the laminated iron core manufacturing apparatus 10 according to the present example embodiment, the finish timing may be the timing when the adhesive spraying finish signal is transmitted to the nozzles 72. The above-described example embodiment is able to more accurately set the finish timing.

In the laminated iron core manufacturing apparatus 10 according to the present example embodiment, the finish timing may be the timing when spraying of the adhesive from the nozzles 72 is finished. The above-described example embodiment is able to more accurately set the finish timing.

In the laminated iron core manufacturing apparatus 10 according to the present example embodiment, the finish timing may be the timing when the adhesive applicator 70 finishes transferring the adhesive to the lower surface WL of the metal plate W. The above-described example embodiment is able to more accurately set the finish timing.

In the laminated iron core manufacturing apparatus 10 according to the present example embodiment, the finish timing may be the timing when the adhesive discharged upward from the discharge ports 72A is transferred to the lower surface WL of the metal plate W and separated from the discharge ports 72A. The above-described example embodiment is able to more accurately set the finish timing.

In the laminated iron core manufacturing apparatus 10 according to the present example embodiment, the application controller 94 may be configured or programmed to change the time interval between the finish of application of the adhesive from the adhesive applicator 70 to the lower surface WL of the metal plate W and the removal of the pilot pins 50 from the pilot holes PH. The above-described example embodiment is able to more accurately apply the adhesive to the predetermined position on the lower surface WL of the metal plate W.

In the laminated iron core manufacturing apparatus 10 according to the present example embodiment, the urging member 32 may be configured to, during the period in which the stripper plate 60 pushes the metal plate W downward against the urging force of the urging member 32, allow the portion WC of the metal plate W (which is located between the portion WA of the metal plate W in contact with the lifter 30 and the portion WB of the metal plate W in contact with the stripper plate 60) to move downward while remaining horizontal. The above-described example embodiment reduces or eliminates curvature of the metal plate W and is thus able to more accurately form the iron cores 5.

In the laminated iron core manufacturing apparatus 10 according to the present example embodiment, the movement controller 92 may be configured or programmed to change the raising and lowering speeds of the upper mold 40. The above-described example embodiment reduces or eliminates curvature of the metal plate W and is thus able to more accurately form the iron cores 5.

In the laminated iron core manufacturing apparatus 10 according to the present example embodiment, the movement controller 92 may be configured or programmed to change the lowermost position LP in accordance with the thickness of the metal plate W. The above-described example embodiment is able to prevent the stripper plate 60 from pressing the metal plate W downward excessively.

The laminated iron core manufacturing apparatus 10 according to the present example embodiment includes the pilot pins 50 provided on the upper mold 40 and to be inserted through the pilot holes PH formed in the band-shaped metal plate W so as to determine the positioning of the metal plate W with respect to the adhesive applicator 70. The application controller 94 of the controller 90 may cause the adhesive applicator 70 to start applying the adhesive to the lower surface WL of the metal plate W after the pilot pins 50 have been inserted through the pilot holes PH. The above-described example embodiment involves causing the adhesive applicator 70 to start applying the adhesive to the lower surface WL of the metal plate W, with the positioning of the metal plate W with respect to the adhesive applicator 70 being determined by the insertion of the pilot pins 50 through the pilot holes PH. Consequently, the above-described example embodiment is able to more accurately apply the adhesive to the predetermined position on the lower surface WL of the metal plate W.

In the laminated iron core manufacturing apparatus 10 according to the present example embodiment, the application controller 94 may cause the adhesive applicator 70 to finish applying the adhesive to the lower surface WL of the metal plate W before the pilot pins 50 are removed from the pilot holes PH. The above-described example embodiment involves finishing the application of the adhesive to the lower surface WL of the metal plate W, with the positioning of the metal plate W with respect to the adhesive applicator 70 being determined by the pilot pins 50. Consequently, the above-described example embodiment is able to more accurately apply the adhesive to the predetermined position on the lower surface WL of the metal plate W.

In the laminated iron core manufacturing apparatus 10 according to the present example embodiment, the application controller 94 may cause the adhesive applicator 70 to finish applying the adhesive to the lower surface WL of the metal plate W at some point between the time at which the pilot pins 50 are located at their bottom dead points and the time before the pilot pins 50 are moved upward from their bottom dead points and removed from the pilot holes PH. The above-described example embodiment involves finishing the application of the adhesive to the lower surface WL of the metal plate W, with the positioning of the metal plate W with respect to the adhesive applicator 70 being determined by the pilot pins 50. Consequently, the above-described example embodiment is able to more accurately apply the adhesive to the predetermined position on the lower surface WL of the metal plate W.

In the laminated iron core manufacturing apparatus 10 according to the present example embodiment, the application controller 94 may cause the adhesive applicator 70 to finish applying the adhesive to the lower surface WL of the metal plate W at some point between the time at which one-half of each insertion portion 50A as measured along the up-down direction Z is removed from the associated pilot hole PH and the time before the entirety of each insertion portion 50A is removed from the associated pilot hole PH. The above-described example embodiment involves finishing the application of the adhesive to the lower surface WL of the metal plate W, with the positioning of the metal plate W with respect to the adhesive applicator 70 being determined by the pilot pins 50. Consequently, the above-described example embodiment is able to more accurately apply the adhesive to the predetermined position on the lower surface WL of the metal plate W.

In the laminated iron core manufacturing apparatus 10 according to the present example embodiment, the application controller 94 may cause the adhesive applicator 70 to apply the adhesive to the lower surface WL of the metal plate W only while the conveyance of the metal plate W is stopped. The above-described example embodiment is able to more accurately apply the adhesive to the predetermined position on the lower surface WL of the metal plate W.

In the laminated iron core manufacturing apparatus 10 according to the present example embodiment, the application controller 94 may cause the adhesive applicator 70 to finish applying the adhesive to the lower surface WL of the metal plate W before each lifter 30 reaches the uppermost position PM. The above-described example embodiment is able to accurately apply the adhesive to the predetermined position on the lower surface WL of the metal plate W while maintaining a suitable distance between the lower surface WL of the metal plate W and the adhesive applicator 70 in the up-down direction Z.

In the laminated iron core manufacturing apparatus 10 according to the present example embodiment, the application controller 94 may cause the adhesive applicator 70 to apply the adhesive to the lower surface WL of the metal plate W only while at least portions of the pilot pins 50 are inserted through the pilot holes PH. The above-described example embodiment involves causing the adhesive applicator 70 to start applying the adhesive to the lower surface WL of the metal plate W, with the positioning of the metal plate W with respect to the adhesive applicator 70 being determined by the insertion of at least portions of the pilot pins 50 through the pilot holes PH. Consequently, the above-described example embodiment is able to more accurately apply the adhesive to the predetermined position on the lower surface WL of the metal plate W.

In the laminated iron core manufacturing apparatus 10 according to the present example embodiment, the application controller 94 may cause the adhesive applicator 70 to apply the adhesive to the lower surface WL of the metal plate W only while at least portions of the pilot pins 50 are inserted through the pilot holes PH and the conveyance of the metal plate W is stopped. The above-described example embodiment involves causing the adhesive applicator 70 to apply the adhesive to the lower surface WL of the metal plate W, with the positioning of the metal plate W with respect to the adhesive applicator 70 being determined by the insertion of at least portions of the pilot pins 50 through the pilot holes PH and with the conveyance of the metal plate W being stopped. Consequently, the above-described example embodiment is able to more accurately apply the adhesive to the predetermined position on the lower surface WL of the metal plate W.

Some example embodiments of the present invention have been described above. The foregoing example embodiments, however, are provided by way of example only. The present invention may be embodied in various other forms, configurations, example embodiments, modifications thereto, etc.

In the forgoing example embodiments, the lower mold body 21 of the lower mold 20, the die plate assembly 22, and the die assembly 23 are separate components, for example. Alternatively, the lower mold body 21, the die plate assembly 22, and the die assembly 23 may be integrated in any suitable combination. In one example, the die plate assembly 22 and the die assembly 23 may be integrated. In another example, the die plate assembly 22, the die assembly 23, and the lower mold body 21 may be integrated.

In the foregoing example embodiments, the upper surface 23T of the die assembly 23 and the upper surface 22T of the die plate assembly 22 are level with each other, for example. The present invention, however, is not limited to this arrangement. In one example, the upper surface 23T of the die assembly 23 may be located below the upper surface 22T of the die plate assembly 22. In this case, the stripper plate 60 presses down the band-shaped metal plate W against the upper surface 22T of the die plate assembly 22.

In the foregoing example embodiments, the die plate assembly 22 and the die assembly 23 are placed on the lower mold body 21, for example. The present invention, however, is not limited to this arrangement. In one example, the die plate assembly 22 and the die assembly 23 may be fitted into recesses that are recessed downward from an upper surface 21T of the lower mold body 21, such that the upper surface 21T of the lower mold body 21, the upper surface 22T of the die plate assembly 22, and the upper surface 23T of the die assembly 23 are level with each other. In this case, the stripper plate 60 presses down the band-shaped metal plate W against the upper surface 21T of the lower mold body 21, the upper surface 22T of the die plate assembly 22, and the upper surface 23T of the die assembly 23.

In the foregoing example embodiments, the manufacturing apparatus 10 includes the controller 90 configured or programmed to include the movement controller 92 and the application controller 94, for example. The present invention, however, is not limited to this arrangement. The manufacturing apparatus 10 may include a controller configured or programmed to include the movement controller 92, and another controller including the application controller 94. In other words, the manufacturing apparatus 10 may include more than one controller.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An apparatus to manufacture a laminated iron core including iron cores laminated and bonded together, the manufacturing apparatus comprising:
a lower mold including a die provided with a die hole;
an upper mold including a punch conforming to the die hole;
an adhesive applicator provided in the lower mold to apply an adhesive to a lower surface of a band-shaped metal plate; and
a controller configured or programmed to control the upper mold and the adhesive applicator; wherein the controller is configured or programmed to include:
a movement controller configured or programmed to control movement of the upper mold in an up-down direction; and
an application controller configured or programmed to change a time interval between a start and a finish of application of the adhesive from the adhesive applicator to the lower surface of the metal plate.

2. The manufacturing apparatus according to claim 1, wherein
the adhesive applicator includes a nozzle below the metal plate and from which the adhesive is to be sprayed onto the lower surface of the metal plate; and
the application controller is configured or programmed to change a timing when spraying of the adhesive from the nozzle starts.

3. The manufacturing apparatus according to claim 1, wherein
the adhesive applicator is configured to apply the adhesive to the lower surface of the metal plate by transferring the adhesive to the lower surface; and
the application controller is configured or programmed to change a timing when the adhesive applicator starts transferring the adhesive to the lower surface of the metal plate.

4. The manufacturing apparatus according to claim 1, further comprising:
a stripper plate provided on the upper mold and movable downward to a lowermost position that is a lowest possible position of the stripper plate, the stripper plate being configured to, at the lowermost position, restrict movement of the metal plate in the up-down direction when the metal plate is punched with the punch;
a lifter provided on the lower mold to push the metal plate upward and being movable downward when the metal plate is pressed downward by the stripper plate; and
an urging member to urge the lifter upward; wherein
the urging member is configured to, during a period in which the stripper plate pushes the metal plate downward against an urging force of the urging member, allow a portion of the metal plate, which is located between a portion of the metal plate in contact with the lifter and a portion of the metal plate in contact with the stripper plate, to move downward while remaining horizontal.

5. The manufacturing apparatus according to claim 4, wherein in a width direction perpendicular, in a plan view, to a conveyance direction in which the metal plate is to be conveyed, a length of the portion of the metal plate, which is located between the portion of the metal plate in contact with the lifter and the portion of the metal plate in contact with the stripper plate, is greater than or equal to about one-half of a length of the lifter.

6. The manufacturing apparatus according to claim 4, wherein in a width direction perpendicular, in a plan view, to a conveyance direction in which the metal plate is to be conveyed, a length of the portion of the metal plate, which is located between the portion of the metal plate in contact with the lifter and the portion of the metal plate in contact with the stripper plate, is greater than or equal to about one-half of a length of a portion of the lifter that is able to come into contact with the metal plate.

7. The manufacturing apparatus according to claim 1, wherein the movement controller is configured or programmed to change raising and lowering speeds of the upper mold.

8. The manufacturing apparatus according to claim 1, further comprising a stripper plate provided on the upper mold and movable downward to a lowermost position that is a lowest possible position of the stripper plate, the stripper plate being configured to, at the lowermost position, restrict movement of the metal plate in the up-down direction when the metal plate is punched with the punch; wherein
the movement controller is configured or programmed to change the lowermost position in accordance with a thickness of the metal plate.

9. The manufacturing apparatus according to claim 1, further comprising a pilot pin provided on the upper mold and to be inserted through a pilot hole in the metal plate so as to determine positioning of the metal plate with respect to the adhesive applicator; wherein
the application controller is configured or programmed to cause the adhesive applicator to start applying the adhesive to the lower surface of the metal plate after the pilot pin has been inserted through the pilot hole.

10. The manufacturing apparatus according to claim 9, wherein the application controller is configured or programmed to cause the adhesive applicator to finish applying the adhesive to the lower surface of the metal plate before the pilot pin is removed from the pilot hole.

11. The manufacturing apparatus according to claim 10, wherein the application controller is configured or programmed to cause the adhesive applicator to finish applying the adhesive to the lower surface of the metal plate at some point between a time at which the pilot pin is located at a bottom dead point and a time before the pilot pin is moved upward from the bottom dead point and removed from the pilot hole.

12. The manufacturing apparatus according to claim 11, wherein
the pilot pin includes an insertion portion to be inserted through the pilot hole; and
the application controller is configured or programmed to cause the adhesive applicator to finish applying the adhesive to the lower surface of the metal plate at some point between a time at which one-half of the insertion portion as measured along the up-down direction is removed from the pilot hole and a time before an entirety of the insertion portion is removed from the pilot hole.

13. The manufacturing apparatus according to claim 1, further comprising a pilot pin provided on the upper mold and to be inserted through a pilot hole in the metal plate so as to determine positioning of the metal plate with respect to the adhesive applicator; wherein
the pilot pin includes an insertion portion to be inserted through the pilot hole;
the application controller is configured or programmed to cause the adhesive applicator to finish applying the adhesive to the lower surface of the metal plate at some point between a time at which one-half of the insertion portion as measured along the up-down direction is removed from the pilot hole and a time before an entirety of the insertion portion is removed from pilot hole; and
the adhesive applicator is configured to apply the adhesive to the lower surface of the metal plate using a contact application process.

14. The manufacturing apparatus according to claim 10, wherein the application controller is configured or programmed to cause the adhesive applicator to apply the adhesive to the lower surface of the metal plate only while conveyance of the metal plate is stopped.

15. The manufacturing apparatus according to claim 9, further comprising:
a stripper plate provided on the upper mold and movable downward to a lowermost position that is a lowest possible position of the stripper plate, the stripper plate being configured to, at the lowermost position, restrict movement of the metal plate in the up-down direction when the metal plate is punched with the punch; and
a lifter provided on the lower mold to push the metal plate upward and movable downward when the metal plate is pressed downward by the stripper plate; wherein
the lifter is movable to an uppermost position when the metal plate is not pressed by the stripper plate; and
the application controller is configured or programmed to cause the adhesive applicator to finish applying the adhesive to the lower surface of the metal plate before the lifter reaches the uppermost position.

16. The manufacturing apparatus according to claim 15, wherein the application controller is configured or programmed to cause the adhesive applicator to apply the adhesive to the lower surface of the metal plate only while conveyance of the metal plate is stopped.

17. The manufacturing apparatus according to claim 1, further comprising a pilot pin provided on the upper mold and to be inserted through a pilot hole in the metal plate so as to determine positioning of the metal plate with respect to the adhesive applicator; wherein
the application controller is configured or programmed to cause the adhesive applicator to start applying the adhesive to the lower surface of the metal plate only while at least a portion of the pilot pin is inserted through the pilot hole.

18. The manufacturing apparatus according to claim 17, wherein the application controller is configured or programmed to cause the adhesive applicator to apply the adhesive to the lower surface of the metal plate only while conveyance of the metal plate is stopped.

19. The manufacturing apparatus according to claim 1, further comprising a pilot pin provided on the upper mold and to be inserted through a pilot hole in the metal plate so as to determine positioning of the metal plate with respect to the adhesive applicator; wherein
the application controller is configured or programmed to cause the adhesive applicator to apply the adhesive to the lower surface of the metal plate only while at least a portion of the pilot pin is inserted through the pilot hole and conveyance of the metal plate is stopped.
